(19) United States
(12) Patent Application Publication
(10) Pub. No.: US 2025/0206649 A1
(43) Pub. Date: Jun. 26, 2025

(54) WASTEWATER SLUDGE DEWATERING

(71) Applicant: SOLENIS TECHNOLOGIES, L.P., Wilmington, DE (US)

(72) Inventor: Martin Riley, Virginia Beach, VA (US)

(73) Assignee: SOLENIS TECHNOLOGIES, L.P., Wilmington, DE (US)

(21) Appl. No.: 18/986,736

(22) Filed: Dec. 19, 2024

Related U.S. Application Data
(60) Provisional application No. 63/612,378, filed on Dec. 20, 2023.

(51) Int. Cl. C02F 11/143; C02F 1/52; C02F 1/72; C02F 101/30

(52) U.S. Cl. CPC C02F 11/143; C02F 1/52; C02F 1/727; C02F 2101/30; C02F 2305/02

(57) ABSTRACT

Methods for treating wastewater and dewatering a discharge sludge stream are provided. In an exemplary embodiment, a method for treating wastewater includes adding oxygen to a wastewater to produce a treated wastewater, and separating a wastewater sludge stream from the treated wastewater. The wastewater sludge stream is split to produce a recycle sludge stream and a discharge sludge stream, and the recycle sludge stream is added to the wastewater such that the oxygen is added to the recycle sludge stream and the wastewater. A peroxide source is added to the discharge sludge stream, and the discharge sludge stream is dewatered to produce a sludge cake and a sludge liquid portion.

This application claims the benefit of U.S. Provisional Application No. 63/612,378, filed Dec. 20, 2023.

### TECHNICAL FIELD

The technical field generally relates to wasteswater treatment, and more particularly relates to dewatering sludge for wastewater treatment facilities.

### BACKGROUND

Many conventional processes for treating wastewater utilize microorganisms to digest contaminants in the wastewater. These microorganisms typically digest the contaminants aerobically, so air or other sources of oxygen are introduced into an aerobic treatment apparatus with the wastewater. The microorganisms reproduce during the aerobic digestion process, and excess organic material needs to be removed from the process. Typically, the microorganisms are collected as a composite sludge at a back end of the aerobic treatment apparatus. This composite sludge is then split into a return activated sludge and a discharge activated sludge. The return activated sludge is added back to the aerobic treatment apparatus and mixed with additional wastewater to sustain the aerobic treatment process.

The discharge activated sludge is dewatered and disposed of. However, the microorganisms in the discharge activated sludge retain significant water and liquid material within the cell walls. This increases the volume and mass of the discharge activated sludge for disposal. The cost of disposal can be quite significant.

Accordingly, it is desirable to provide systems and methods that reduce the quantity of discharged activated sludge for disposal. In addition, it is desirable to provide systems and methods that reduce the water content in the discharge activated sludge. Furthermore, other desirable features and characteristics of the present embodiments will become apparent from the subsequent detailed description and the appended claims, taken in conjunction with the accompanying drawings and this background.

### BRIEF SUMMARY

Methods for treating wastewater and dewatering a discharge sludge stream are provided. In an exemplary embodiment, a method for treating wastewater includes adding oxygen to a wastewater to produce a treated wastewater, and separating a wastewater sludge stream from the treated wastewater. The wastewater sludge stream is split to produce a recycle sludge stream and a discharge sludge stream, and the recycle sludge stream is added to the wastewater such that the oxygen is added to the recycle sludge stream and the wastewater. A peroxide source is added to the discharge sludge stream, and the discharge sludge stream is dewatered to produce a sludge cake and a sludge liquid portion.

A method of dewatering a discharge sludge stream is provided in another embodiment. The method includes adding a hydrogen peroxide source and a flocculant to the discharge sludge stream. The discharge sludge stream is then dewatered to produce a sludge cake and a sludge liquid portion.

Another method of dewatering a discharge sludge stream is provided in yet another embodiment, where the discharge sludge stream includes a plurality of microbes. The method includes rupturing a microbe cell membrane with hydrogen peroxide, and dewatering the discharge sludge stream to produce a sludge cake and a sludge liquid portion.

### BRIEF DESCRIPTION OF THE DRAWINGS

The present embodiments will hereinafter be described in conjunction with the following drawing figures, wherein like numerals denote like elements, and wherein:

FIG. 1 is a schematic diagram of a wastewater treatment system.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Wastewater or other effluent is delivered to an aerobic treatment apparatus of a wastewater treatment system, where contaminants in the wastewater are aerobically treated. The aerobic treatment apparatus generally produces three main components: (1) treated water; (2) carbon dioxide; and (3) excess microbes, where the microbes aerobically degrade contaminants in the wastewater in the aerobic treatment apparatus. The treated water is then sent to a liquid/solid separation apparatus, where the excess microbes are settled and separated from the treated water. The settled microbes are discharged as a slurry in a wastewater sludge stream, and the treated water is discharged as a treated wastewater stream. Some of the wastewater sludge stream is circulated back to the aerobic treatment apparatus in a recycled sludge stream to sustain the aerobic treatment process, and some of the wastewater sludge stream is separated for disposal in a discharge sludge stream. The microbes include significant quantities of water within their cell walls, and this water increases the volume and mass of the discharge sludge stream. The solids from the discharge sludge stream is typically disposed of, and disposal costs depend on volume and/or mass. Therefore, a technique to lyse the cell walls of the microbes can reduce the amount of water in the microbes from the discharge sludge stream, because the water released from the cell walls can be discharged or used separately from the sludge solids. It has been discovered that a hydrogen peroxide source lyses the cells, and can be used to reduce the volume and mass of the discharge sludge stream.

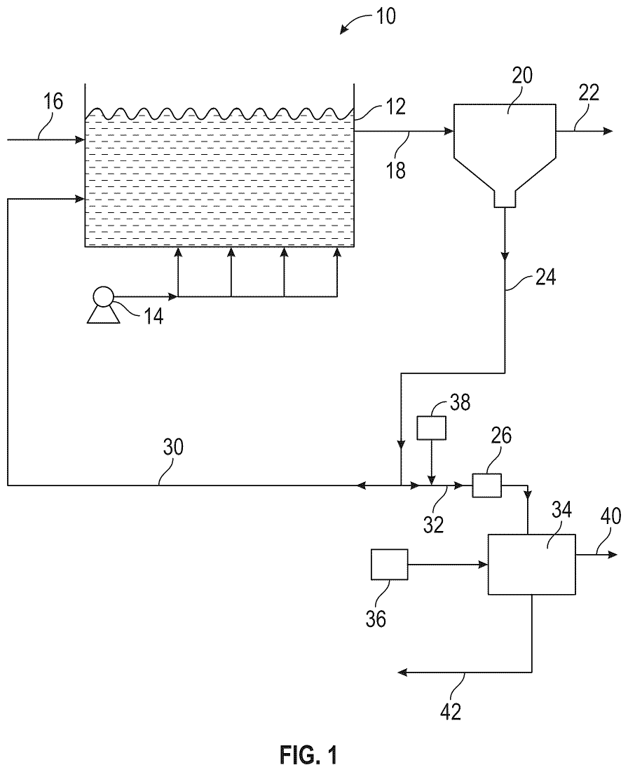

An exemplary embodiment is illustrated in FIG. 1. A wastewater treatment system 10 includes an aerobic treatment apparatus 12, and an oxygen source 14 introduces oxygen into the aerobic treatment apparatus 12. Untreated wastewater 16 enters the aerobic treatment apparatus 12, and the oxygen is mixed with the wastewater. The microbes in the aerobic treatment apparatus 12, combined with the oxygen from the oxygen source 14, aerobically digest and treat contaminants in the untreated wastewater 16. Treated wastewater 18 exits the aerobic treatment apparatus 12 and enters a liquid/solid separation apparatus 20. The liquid/solid separation apparatus 20 separates solids from liquids, and produces a treated discharge stream 22 that is largely free of solids and a wastewater sludge stream 24 that includes most of the solids from the treated wastewater 18. The treated discharge stream 22 is then discharged from the wastewater treatment system 10, such as by flowing into the environment or to another use.

The wastewater sludge stream 24 is divided into a recycle sludge stream 30 and a discharge sludge stream 32. The recycle sludge stream 30 is returned to the aerobic treatment apparatus 12 to sustain the ongoing aerobic treatment process. The discharge sludge stream 32 proceeds to a dewatering apparatus 34, where liquids and solids are further separated. A peroxide source 36 provides a source of hydrogen peroxide that is combined with the discharge sludge stream 32 to lyse at least some of the cell membranes, and thereby reduce the amount of liquid retained with the microbes in solids of the discharge sludge stream 32. An optional flocculant source 38 may also provide a flocculant to the dewatering apparatus to facilitate separation of the solids and the liquids in the discharge sludge stream 32.

The dewatering apparatus 34 produces a sludge liquid portion 40 that is relatively free of solids, and a sludge cake 42 for disposal. The sludge liquid portion 40 may be returned to the aerobic treatment apparatus 12, conveyed to some other location at the wastewater treatment system 10, discharged into the environment, or used for other purposes. The sludge cake 42 is typically disposed of, such as by landfilling or incineration.

The aerobic treatment apparatus 12 uses oxygen, typically provided by air, in conjunction with microbes to digest contaminants in the wastewater. In an exemplary embodiment, the oxygen source 14 is a pump or blower that injects air into a lower portion of the aerobic treatment apparatus 12, but other embodiments are also possible. Various possible embodiments of the aerobic treatment apparatus 12 include, but are not limited to, (i) an activated sludge reactor, (ii) an oxygen-activated sludge wastewater treatment system (UNOX), (iii) a trickling filter, (iv) an aeration basin, (v) an oxidation ditch, (vi) a rotating biological contactor, (vii) a sequencing batch reactor, (viii) a membrane bioreactor and (ix) a suspended media system. These various possible embodiments, and other potential embodiments, may be used alone or in combination, and may include more than one of a single type of embodiment. The oxygen source 14 (or oxygen sources 14) may be chosen by those skilled in the art, and a wide variety of options are possible.

The untreated wastewater 16 may result from a wide variety of different sources. For example, the untreated wastewater 16 may be produced from municipal locations, industrial locations, waste treatment locations, etc. The treated discharge stream 22 is typically piped to the environment, such as a permitted National Pollutant Discharge Elimination System (NPDES) discharge location. However, the treated discharge stream 22 may also be incorporated into a water supply, or otherwise used. For example, the treated discharge stream 22 may be used as all or part of a water source for an industrial facility or a municipality, for farming operations, etc.

The liquid/solid separation apparatus 20 can be a wide variety of devices. Exemplary liquid/solid separation apparatus's 20 include, but are not limited to, a clarifier, a filter, a membrane, a belt filter press, a screw press, a decanter centrifuge, a plate and frame filter press, geo-textile bags, gravity belt thickener, rotary drum thickener, dewatering box, drying bed or other devices.

The wastewater sludge stream 24 may include about 5 weight percent solids, based on a total weight of the wastewater sludge stream 24. However, other concentrations of solids are possible, and the solids concentration tends to vary at different times. Typical solids values tend to range from about 0.5 to about 6 weight percent solids, but values outside of this range are also possible. The solids in the wastewater sludge stream 24 may primarily be microbes produced by the aerobic treatment process, and these microbes may include from about 50 to about 85 weight percent water that is retained within the cell membranes, based on a total weight of the microbes. As such, the water retained within the cell membranes does not separate out with the treated discharge stream 22. These microbes are valuable for the aerobic treatment process in the aerobic treatment apparatus 12, so a portion of the wastewater sludge stream 24 is split off as the recycle sludge stream 30 and returned to the aerobic treatment apparatus 12 to aid in degradation of any contaminants in the untreated wastewater 16.

Another portion of the wastewater sludge stream 24 is split off as the discharge sludge stream 32. The microbes and other solids in the discharge sludge stream 32 are destined for disposal in a sludge cake 42. However, disposal comes as an expense, so it is desirable to minimize the quantity of solids produced. The water within the cell membranes of the microbes, if released, could reduce the quantity of solids significantly. There are several techniques that can rupture or lyse the cell membranes, but many of these techniques also damage or interfere with polymers that are typically used as a flocculant. For example, bleach interferes with polymer flocculation to a greater extent than hydrogen peroxide. Bleach and lime also can lyse cells, but these compounds raise the pH and interfere with the polymer flocculation process. As an added benefit, the hydrogen peroxide tends to keep hydrogen sulfide in an aqueous solution, so malodors from hydrogen sulfide are also reduced by the addition of hydrogen peroxide.

The flocculant aids in the separation of the solids from the liquid, so a lysing technique that does not interfere with the flocculant is desirable. Any lysing technique utilized will kill the microbes, so the lysing technique is applied to the discharge sludge stream 32 after the recycle sludge stream 30 has been separated, such that the microbes in the recycle sludge stream 30 are still alive and viable for aerobic digestion of contaminants in the aerobic treatment apparatus 12.

In an exemplary embodiment, hydrogen peroxide is used for lysing the cell membranes of the microbes. As such, a peroxide source 36 is added to the discharge sludge stream 32 in a dewatering apparatus 34, where the discharge sludge stream 32 is dewatered in the dewatering apparatus 34. The peroxide source 36 provides hydrogen peroxide to the discharge sludge stream 32, and that hydrogen peroxide may be provided in a variety of manners. For example, the hydrogen peroxide may be added as an aqueous mixture at a variety of concentrations, where the aqueous mixture is in a liquid form. Alternatively, the hydrogen peroxide may be added as a solid, where the solid generates hydrogen peroxide in the presence of water. Exemplary hydrogen peroxide generating solids include, but are not limited to, percarbonate, perborate, urea hydrogen peroxide, calcium peroxide, magnesium peroxide, and percarbamide. Combinations of these solids may also be utilized, if desired, as well as combinations of solid and liquid hydrogen peroxide sources.

In an exemplary embodiment, the hydrogen peroxide is added as an aqueous solution of hydrogen peroxide at a concentration of from about 3 to about 35 weight percent hydrogen peroxide, based on a total weight of the aqueous solution of hydrogen peroxide. However, in alternate embodiments, the aqueous solution of hydrogen peroxide has a concentration of from about 1 to about 100 weight percent, or from about 1 to about 90 weight percent, or from about 3 to about 50 weight percent, or from about 3 to about 35 weight percent (as mentioned above), or from about 3 to about 6 weight percent, all based on a total weight of the aqueous solution of hydrogen peroxide. Higher concentrations of hydrogen peroxide may be explosive, so lower concentrations may reduce safety issues. However, more material must be added to produce the same effect when lower concentrations are used.

The peroxide source 36 is added to the discharge sludge stream 32 in such a manner as to form a desired concentration of hydrogen peroxide in the discharge sludge stream 32. For example, the peroxide source 36 may add sufficient material to produce a concentration of from about 10 to about 500,000 parts per million (ppm) by weight of hydrogen peroxide, based on a total weight of the discharge sludge stream. In alternate embodiments, the peroxide source 36 may add sufficient material to produce a concentration of from about 20-100,000 ppm by weight, or from about 30-50,000 ppm by weight, or about 50-1,000 ppm by weight, or about 100-500 ppm by weight, or from about 300-350 ppm by weight, all based on a total weight of the discharge sludge stream, where the second number in the range is also modified by the word “about.”

The quantity and concentration of hydrogen peroxide may be determined based on economics. There is a cost associated with the addition of the peroxide source 36, and there is a savings from reduced disposal costs resulting from a decrease in the amount of solids generated in the sludge cake 42. The quantity of hydrogen peroxide utilized for cell lysing can be optimized such that the total cost of operation is minimized. This can be determined for a specific wastewater treatment system 10, because the microbes, wastewater, and other factors for each specific wastewater treatment system 10 can vary. As such, the optimum quantity of hydrogen peroxide will also vary from one wastewater treatment system 10 to another. For example, the cost of the peroxide source 36 may be compared to a cost difference for disposal, where an average disposal cost is determined before the peroxide source 36 was added, and an average disposal cost is determined after the peroxide source 36 is added. The difference in the average disposal cost from (i) before the peroxide source 36 was added and from (ii) after the peroxide source 36 was added may be utilized as the disposal cost savings.

The flocculant source 38 adds a flocculant to the water at some point in the operation of the wastewater treatment system 10. The flocculant source 38 may add the flocculant prior to or within the liquid/solid separation apparatus 20, prior to or after the separation of the wastewater sludge stream 24 into the recycle sludge stream 30 and the discharge sludge stream 32, in the dewatering apparatus 34, or a combination of these locations. After the flocculant has been added to the water, the water may be mixed by a mixer 26 in an exemplary embodiment. The mixer 26 may be an in-line mixer, but a wide variety of other options are also possible. FIG. 1 illustrates the flocculant source 38 adding flocculant to the discharge sludge stream 32, and the mixer 26 positioned downstream from the addition point of the flocculant in that discharge sludge stream 32. However, many other locations are possible in alternate embodiments.

The dewatering apparatus 34 may include a mixing device (not individually illustrated within the dewatering apparatus 34) to aid in the distribution of the hydrogen peroxide within the discharge sludge stream 32. This may be an in-line mixer in some embodiments, but other techniques are also possible. For example, the peroxide source 36 may be configured to add the peroxide from a plurality of jets into the discharge sludge stream 32 such that normal turbulent flow provides adequate mixing, or an agitator, recirculation pump, or other mixing technique may be utilized. It is also possible to utilize a combination of the same or different mixing devices. The dewatering apparatus 34, as described herein, includes the addition point for the peroxide source 36, the optional mixing device, the actual separation device used for separating solids from liquids, and ancillary equipment associated therewith. However, in alternate embodiments, the addition point of the peroxide source 36, the optional mixing device, and various ancillary equipment may be considered to be outside of the dewatering apparatus 34.

### EXPERIMENTAL

Exemplary laboratory procedures are described below, but it is also possible to utilize other laboratory procedures. Consistent procedures produce results that are more reliable for comparison.

### Free Drainage Test

This method is a laboratory simulation technique that facilitates selection of polyelectrolytes for use as sludge dewatering aids in full scale applications in which free drainage is an important parameter. The method is used to assess the effectiveness of flocculants in terms of the free drainage of liquor from sludge solids.

A sludge sample is flocculated, and the treatment is evaluated based on its effectiveness in releasing water from the sludge solids. This is accomplished by allowing the flocculated sludge to free drain through a tube containing a piece of belt press cloth and measuring the volume of filtrate collected after a set length of time. Various products at various dosages may be compared due to the fact that all data is generated under the same test conditions.

### Preparation of Reagents and Substrate Samples

1. Mix or shake the sludge sample to be used as the test substrate. The dry solids content of the sludge sample being used should have been previously determined.
2. Measure out the required amount of sludge needed for testing into 3 liter (L) plastic jugs. If the substrate has not previously been screened, place a ¼″ mesh wire screen over the container before pouring. Repeat Steps 1 and 2 when further sludge samples are required.
3. For each product to be used for testing, prepare 200 mL of a 1% active product solution.
4. Dilute each stock solution to an appropriate volume and an appropriate concentration.

### Procedure for Free Drainage Testing

1. Using an appropriately sized plastic measuring cylinder, measure out a 200 ml aliquot of sludge into a 600 ml short form plastic beaker.
2. Using the appropriately sized syringe, measure out a reasonable dosage of a product being used as a reference. Please note that the dosage being used as the starting dosage should be close to optimum and may be obtained from provided plant data or may need to be approximated.
3. Add the polymer solution to a second low form plastic beaker.
4. Transfer the sludge into the polymer and pour back and forth between the two until a visually optimal floc has formed. Count the number of pours so mixing energy can be repeated throughout the evaluation.
5. Free drain the treated sample by simultaneously pouring this conditioned sample into the drainage tube while starting a stopwatch. Record the volumes of filtrate obtained after both 5 and 10 seconds.
6. Wash all of the solids from the cloth of the drainage tube, and assemble the free drainage apparatus again.
7. Calculate the corrected free drainage using the equation below. This calculation corrects for the volume of polymer solution added.

$$Corrected Free Drainage = A / ( ( A + B ) C )$$

$$Where :$$

$$B = the volume of dosage used$$

$$C = free drainage volume experimentally obtained$$

$$A = the total volume of liquid possible from the sludge = ( V - ( VS ) ) / 100$$

$$V = the volume of sludge used for testing$$

$$S = the \% solids content of the sludge used for testing .$$

8. Repeat this process for the same product over a dose range with the objective being to generate a free drainage volume at many dosages of the product being tested thus producing a detailed curve which includes poor performance, optimum performance, and overdosing. Please note that 5-7 dosages of a product are generally necessary to obtain a detailed curve.

### Total Dry Solids Determination

Knowing the dry solids content of sewage sludge enables the calculation of accurate polymer dosages in pounds of polymer per ton of dry solids (or indeed in kilograms of polymer per tonne of dry solids). Therefore, the measurement of the dry solids content of sewage sludge is a desirable part of sludge characterization. Additionally, this procedure may be used to determine the dry solids content of sludge cakes. The dryness of sludge cakes is used in many applications to measure the effectiveness of a polymer treatment and/or a lysing treatment. The percent dry solids content of either a sludge sample or a sludge cake is determined in duplicate by gravimetric means.

Procedure for the Determination of Sludge Solids using Microwave Method *Note: The CEM Lab Wave Microwave Oven should not be used as the final reported solids value for samples. The % solids value determined by the Microwave will vary (as much as 10%) based on how the sample was applied to the drying pads. Thus, data from the Microwave should be used as an estimated solids value when a quick solids content is needed. Use crucible dry weight for official solids reporting.
1. Press START on the CEM Lab Wave 9000 Microwave Oven.
2. Press F4 until the PROGRAM SELECT MENU appears on the screen. At the top of the screen, it will be written SELECT NEW PROGRAM.
3. Use the up and down arrows to select Method “1”. Press ENTER.
4. Open the microwave door to find the microwave pads inside. Take 2 of them and place them on the balance in the center of the microwave. Close the door tightly.
5. Press TARE. When balance is tared, a beep will sound. The beep indicates that the microwave is ready for the addition of the sample to be analyzed to the pads.
6. Apply the sample to one of the pads. Using a pipette, spread 2-4 grams of sample onto the pad, ensuring not to puddle an excess amount of sample in one concentrated spot. Place the other pad on top of the pad with the sample on it. The end results should be 2 pads with the sample between them.
7. Place the pads back upon the glass balance in the microwave and close door tightly.
8. Press START. When the drying is complete, the results will be indicated on the screen. The % solids will be displayed. If not, press F2 until % SOLIDS is indicated.

### Procedure for the Determination of Sludge Solids

1. An aliquot of sludge should be sampled.
2. Dry the crucibles to be used for 15 minutes in an over at 110° C.
3. Place the crucibles in the desiccator, and allow to cool.
4. Weigh the first crucible, record the weight, and tare the balance.
5. Stir the sludge sample well with the glass rod, and fill the tared crucible with sludge.
6. Record the weight of sludge taken.
7. Repeat Steps 4 through 6 for the duplicate sample.
8. Place both crucibles in the 110° C. oven overnight.
9. Remove the crucibles from the oven, place in the desiccator, and allow to cool.
10. Reweigh both crucibles containing the dry solids.
11. Calculate the average of both percent dry solids determinations as outlined below in “Procedure for the Calculation of Percent Dry Solids.”

### Procedure for the Calculation of Percent Dry Solids

1. Calculate the percent dry solids (% D.S.) for each sample by using the equation below.

$$\% D . S . = ( D - C ) / W * 100$$

$$Where : D = Crucible + dry sludge weight$$

$$C = Crucible weight$$

$$W = Wet sludge weight$$

2. The average of both percent dry weight determinations is calculated.

### Procedure for the Determination of Sludge Cake Solids

1. The sludge cake should be analyzed immediately after being generated or should have been previously stored in a in a manner that minimizes evaporation.
2. Dry the dishes to be used for 15 minutes in an over at 110° C.
3. Place the dishes in the desiccator, and allow to cool.
4. Weigh the first dish, and record the weight. If convenient, all dishes may be pre-weighed and the corresponding weight written on each for use as the reference number.
5. Fill the pre-weighed dish with wet cake sample. If the cake is being taken from a plastic bag, be sure to roll and mix the cake in the bag to collect all condensation from the bag walls.
6. Record the weight of the dish plus wet cake.
7. Repeat Steps 4 through 6 for the duplicate sample.
8. Place both dishes in the 110° C. oven overnight.
9. Place the dishes in the desiccator, and allow to cool.
10. Reweigh both dishes containing the dry cakes.
11. Calculate the average of both percent cake solids determinations as outlined below in “Procedure for the Calculation of Percent Cake Solids.”

### Procedure for the Calculation of Percent Cake Solids

1. Calculate the percent cake solids for each sample by using the equation below.

$$\% Cake = ( D - C ) / ( W - C ) * 100$$

$$Where : D = Dish + dry cake weight$$

$$C = Dish weight$$

$$W = Dish + wet cake weight$$

2. The average of both percent dry weight determinations is calculated.

The following data illustrates the increased percent solids in the sludge cake when using hydrogen peroxide in varying non-limiting embodiments.

TABLE 1

| Sample | Flocculate dosage | | Cake solids |
|---|---|---|---|
| No. | (lb/dry ton) | H₂O₂ ppm | (wt. %) |
| 1 | 50 | 0 | 24 |
| 2 | 50 | 350 | 30 |
| 3 | 55 | 0 | 25 |
| 4 | 55 | 350 | 32 |
| 5 | 60 | 0 | 26 |
| 6 | 60 | 350 | 33 |
| 7 | 65 | 0 | 24 |
| 8 | 65 | 350 | 32 |

The flocculate used was Zalta ® MF 8612

As can be seen, the addition of H₂O₂ results in a higher wt. % cake solids than the same flocculate dosage without the H₂O₂. The higher wt. % solids in the sludge cake 42, the less water there is to dispose of with the sludge cake 42. This increase in the wt. % solids in the sludge cake 42 can provide reduced disposal costs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A method of treating wastewater, the method comprising the steps of:
adding oxygen to a wastewater to produce a treated wastewater;
separating a wastewater sludge stream from the treated wastewater;
splitting the wastewater sludge stream to produce a recycle sludge stream and a discharge sludge stream;
adding the recycle sludge stream to the wastewater such that the oxygen is added to the recycle sludge stream and the wastewater;
adding a peroxide source to the discharge sludge stream; and
dewatering the discharge sludge stream to produce a sludge cake and a sludge liquid portion.

2. The method of claim 1, further comprising:
adding a flocculant to the discharge sludge stream prior to dewatering the discharge sludge stream.

3. The method of claim 1, wherein the peroxide source is added in an amount of from about 10 to about 500,000 parts H₂O₂ per million by weight, based on a total weight of the discharge sludge stream.

4. The method of claim 1, wherein the peroxide source is added in an amount of from about 20 to about 100,000 parts H₂O₂ per million by weight, based on a total weight of the discharge sludge stream.

5. The method of claim 1, wherein the peroxide source is added in an amount of from about 30 to about 50,000 parts H₂O₂ per million by weight, based on a total weight of the discharge sludge stream.

6. The method of claim 1, wherein the peroxide source is added in an amount of from about 50 to about 1,000 parts H₂O₂ per million by weight, based on a total weight of the discharge sludge stream.

7. The method of claim 1, wherein the peroxide source is added in an amount of from about 100 to about 500 parts H₂O₂ per million by weight, based on a total weight of the discharge sludge stream.

8. The method of claim 1, wherein the peroxide source is added in an amount of from about 300 to about 350 parts H₂O₂ per million by weight, based on a total weight of the discharge sludge stream.

9. The method of claim 1, wherein the peroxide source comprises hydrogen peroxide in an aqueous carrier.

10. The method of claim 9, wherein the hydrogen peroxide is present in the peroxide source at a concentration of from about 3 to about 35 weight percent, based on a total weight of the peroxide source.

11. The method of claim 1, wherein the peroxide source comprises one or more of a percarbonate, a perborate, urea hydrogen peroxide, calcium peroxide, magnesium peroxide, percarbamide, and combinations thereof.

12. The method of claim 1, wherein the peroxide source is added in a quantity such that a total cost of (i) a disposal cost of the sludge cake and (ii) an acquisition cost of the peroxide source is minimized.

13. The method of claim 1, further comprising:
mixing the discharge sludge stream after adding the peroxide source and prior to dewatering the discharge sludge stream.

14. The method of claim 13, wherein mixing the discharge sludge stream comprises passing the discharge sludge stream through an inline mixer.

15. A method of dewatering a discharge sludge stream in a wastewater treatment system, the method comprising the steps of:
adding a peroxide source to the discharge sludge stream, wherein the peroxide source provides hydrogen peroxide;
adding a flocculant to the discharge sludge stream; and
dewatering the discharge sludge stream to produce a sludge cake and a sludge liquid portion.

16. The method of claim 15, wherein the peroxide source is added in an amount of from about 30 to about 50,000 parts H₂O₂ per million by weight, based on a total weight of the discharge sludge stream.

17. The method of claim 15, wherein the peroxide source is added in an amount of from about 50 to about 1,000 parts H₂O₂ per million by weight, based on a total weight of the discharge sludge stream.

18. A method of dewatering a discharge sludge stream in a wastewater treatment system, the method comprising the steps of:
rupturing a microbial cell membrane with hydrogen peroxide, wherein the discharge sludge stream comprises a plurality of microbial cells, and wherein the microbial cells comprise the microbial cell membrane;
dewatering the discharge sludge stream to produce a sludge cake and a sludge liquid portion.

19. The method of claim 18, further comprising:
adding a peroxide source to the discharge sludge stream, wherein the peroxide source provides hydrogen peroxide in an amount of from about 30 to about 50,000 parts H₂O₂ per million by weight, based on a total weight of the discharge sludge stream.

20. The method of claim 18, further comprising:
adding a peroxide source to the discharge sludge stream, wherein the peroxide source provides hydrogen peroxide in an amount of from about 50 to about 1,000 parts H₂O₂ per million by weight, based on a total weight of the discharge sludge stream.
